(19) United States
(12) Patent Application Publication
(10) Pub. No.: US 2005/0237436 A1
(43) Pub. Date: Oct. 27, 2005

(54) Electronic device operated by remote controller

(75) Inventor: Kayo Teramoto, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/099,030

(22) Filed: Apr. 5, 2005

(30) Foreign Application Priority Data
Apr. 5, 2004 (JP) JP2004-110934

(51) Int. Cl. H04N 5/44

(52) U.S. Cl. 348/734; 434/307 R

(57) ABSTRACT

When an operation mode is changed into a demonstration mode by a mode changing unit, a guidance image outputting unit outputs a guidance screen on which names of keys attached to a remote controller and operation contents of a device body which can be used when the keys are depressed are correlated with each other. For this reason, a user can see the guidance screen to confirm the key on the remote controller and the operation contents of the device body. In a status where this guidance screen is being outputted, when a key on the remote controller is operated, a demonstration unit demonstrates an operating procedure when the function corresponding to the operated key is used.

### BACKGROUND OF THE INVENTION

1. Field of the Invention

This invention relates to an electronic device such as a television receiver, a video tape recorder and a DVD player which are remote-controlled by a remote controller.

2. Description of the Related Art

Conventionally, electronic devices such as a television receiver, a video tape recorder and a DVD player which are remote-controlled by a remote controller have become generally widespread. The sophistication or enhanced function of the electronic devices has been developed for responding to the demands from a user. On the other hand, because of the sophistication, when the user employs a certain function, the number of keys which the user must operate has been increased, thus giving a tendency of complicating the operating procedure. So, in order that the operating procedure when using the sophisticated function can be easily confirmed, the techniques for showing the operating procedure to the user were proposed in JP-A-7-107568 and JP-A-2001-306428. JP-A-7-107568 discloses a configuration for guiding a user to an operation to be executed subsequently when actually using the function. JP-A-2001-306428 discloses a configuration for displaying the operating procedure for the function designated by the user.

### SUMMARY OF THE INVENTION

However, in recent years, in addition to the sophistication, a new function(s) has been added to satisfy the demand by the user more. On the other hand, there are some newly added functions whose contents (function actually performed) cannot be known immediately from the names appended to the keys of the remote controller. In such a case, by reading the operating manual, the user can know the contents of the function which cannot be understood from the key name. However, because it is troublesome to read the operating manual, many users do not employ these functions. Thus, the multifunction electronic device has not been effectively employed. Further, not using the usable function is unfavorable for the user also.

An object of this invention is to provide an electronic device operated by a remote controller in which a function attached to a device body can be effectively used by intelligibly informing a user of the contents of the function attached to the device body through a simple operation.

This invention provides an electronic device operated by a remote controller having keys, the electronic device including: a device body; a remote control receiving unit for receiving a control signal designating an operation of the device body transmitted from the remote controller to control the operation of the device body based on the received control signal; a mode changing means for selectively changing an operation mode of the device body between a normal mode and a demonstration mode that explains functions provided to the device body; a guidance image outputting means for outputting, when the mode changing means changes the operation mode of the device body from the normal mode to the demonstration mode, a guidance screen on which contents of functions of the device body and names of the keys attached to the remote controller and operated when the functions are used are correlated with each other; and a demonstration means for guiding, when the guidance image outputting means is outputting the guidance screen, an operating procedure when the function corresponding to the control signal transmitted from the remote controller is used.

In this configuration, the mode changing means changes the operation mode of the device body between a normal mode and a demonstration mode. The normal mode is a mode when a user uses the device body. The demonstration mode is a mode of intelligibly informing the user of the contents of the functions attached to the device body. The user changes the operation mode of the device body into the demonstration mode when he cannot understand the actual contents of the functions of the device body. When the mode changing means changes the operation mode of the device body into the demonstration mode, the guidance image outputting means for outputs, a guidance screen on which the names of the keys attached to the remote controller and the operation contents of the device body when the keys are operated are correlated with each other. For this reason, the user can see the guidance screen to confirm the keys of the remote controller and the operation contents of the device body when the keys are operated. In other words, even when the user cannot know the contents of the functions on the basis of the names (key names) appended to the keys attached to the remote controller, he has only to change the operating mode of the device body into the demonstration mode to confirm the contents of the functions.

Further, in a status where the guidance screen is being outputted when a key on the remote controller is operated, a demonstration means demonstrates an operating procedure when the function corresponding to the operated key is used. For this reason, by changing the operation mode into the demonstration mode, the user can easily confirm the operating procedure when using the function with the confirmed contents.

In this way, through a simple operation, the contents of a function attached to a device body can be intelligibly informed the user. Also, the functions of the device body can be effectively used by the user.

This invention can be applied to not only electronic devices such as a television receiver, a VTR, and a DVD player but also to a TV-integral type VTR (composite apparatus of TV and VTR) and a TV-integral type DVD player (composite apparatus of TV and DVD player).

In accordance with this invention, a function attached to a device body can be effectively used by a user by intelligibly informing the user of the contents of the function attached to the device body through a simple operation.

### BRIEF DESCRIPTION OF THE DRAWINGS

FIG. 1 is a block diagram showing a composite apparatus of a television receiver and a DVD according to an embodiment of this invention;

FIG. 2 is a flowchart showing the operation in a demonstration mode of a TV-integral type DVD according to an embodiment of this invention;

FIG. 3 is a view showing an exemplary display screen of the TV-integral type DVD player according to an embodiment of this invention;

FIG. 4 is a view showing an exemplary display screen of the TV-integral type DVD player according to an embodiment of this invention;

FIG. 5 is a view showing an exemplary display screen of the TV-integral type DVD player according to an embodiment of this invention;

FIG. 6 is a view showing an exemplary display screen of the TV-integral type DVD player according to an embodiment of this invention; and

FIG. 7 is a view showing an exemplary display screen of the TV-integral type DVD player according to an embodiment of this invention.

### DETAILED DESCRIPTION OF THE PREFERRED EMBODIMENTS

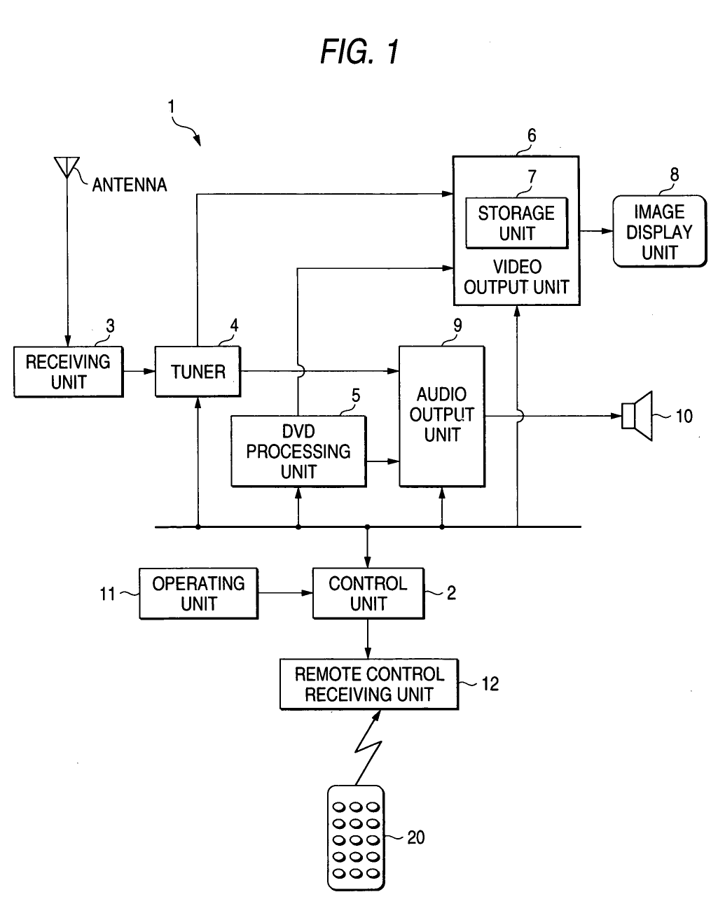

FIG. 1 is a block diagram of a composite machine including a television receiver and a DVD player according to an embodiment of this invention (hereinafter referred to as a TV-integral type DVD player). The TV-integral type DVD player 1 according to the embodiment includes a control unit 2, a receiving unit 3, a tuner 4, a DVD processing unit 5, a video output unit 6, a storage unit 7, an image display unit 8, an audio output unit 9, a speaker 10, an operating unit 11 and a remote control receiving unit 12.

The control unit 2 has a function of selectively changing the operation mode of a device body between a normal mode and a demonstration mode for explaining each of the functions attached to the device body (mode changing means). The control unit 2 also informs the video output unit 6 of that the operation mode has been changed into the demonstration mode and designates the start of the guidance of the operating procedure by a demonstration screen (described later) for the video output unit 6. The receiving unit 3 fetches a television broadcasting signal received by the antenna 3 and supplies it to the tuner 4. The tuner 4 extracts the signal at the channel being received and supplies the extracted signal to the video output unit 6 and the audio output unit 9. The DVD processing unit 5 has a reproducing function of reading video and audio data recorded on a set DVD and supplying reproduced signals to the video output unit 6 and audio output unit 9 and a recording function of recording inputted video and audio data on the DVD.

The control unit 2 functions as the mode changing means, a guidance image outputting means and a demonstration means. The DVD processing unit 5 functions as a reproducing means.

The video output unit 6 converts the video signal supplied from the tuner 4 or the DVD processing unit 5 into the signal for display to be outputted. The video output unit 6 also includes a storage unit which stores a guidance screen which correlates the contents of each of functions attached to a device body for the demonstration mode with the names of keys of the remote controller to be operated using the function and a demonstration screen for guiding the operating procedure when using the function. The demonstration screen referred to here corresponds to an operation guiding screen. The storage unit 7 may be a non-volatile memory such as an EEPROM. In the demonstrate mode, the video output unit 6 outputs the guidance screen and the demonstration screen which are stored in the storage unit 7. On the basis of the video signal supplied from the video output unit 6, the image display unit 8 displays the guidance screen or demonstration screen, the television program being broadcasted or the image recorded on the DVD. The audio output unit 9 processes the audio signal supplied from the tuner 4 or DVD processing unit 5 and outputs the voice thus acquired from the speaker 10. The operating unit 11 executes the selection of the channel received at the antenna 4 and various setting operations. The remote control receiving unit 12 receives the control signal for the device body transmitted from the remote controller 20 and sends it to the control unit 2. The remote controller 20 is provided to execute the selection of the channel received at the tuner and various setting operations at a position remote from the device body, and transmits the control signal according to the operated key through a radio wave or infrared rays.

An explanation will be given of the operation of the electronic device according to this embodiment. This electronic device has two mode of the normal mode and demonstration mode. Changing the normal mode into the demonstration mode and vice versa can be done using the remote controller or operating unit.

The normal mode is a mode of watching the television program being broadcasted, reproducing the contents recorded on the DVD or recording the television program. In this mode, for example, the user who is watching the television changes the channel using the remote controller and selects a preferred program to watch. The operation in the normal mode, which is well known, will not be explained in detail.

The demonstration mode is a mode of causing a user to confirm the names of the keys on the remote controller 20 and contents of the functions which can be employed when these keys are operated and guiding the operating procedure when using each of these functions.

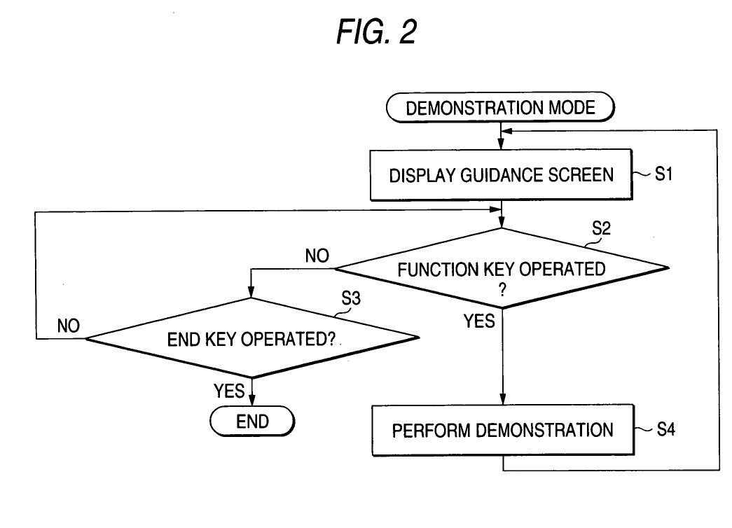

FIG. 2 is a flowchart of the operation in the demonstration mode. The demonstration mode will be explained below in detail.

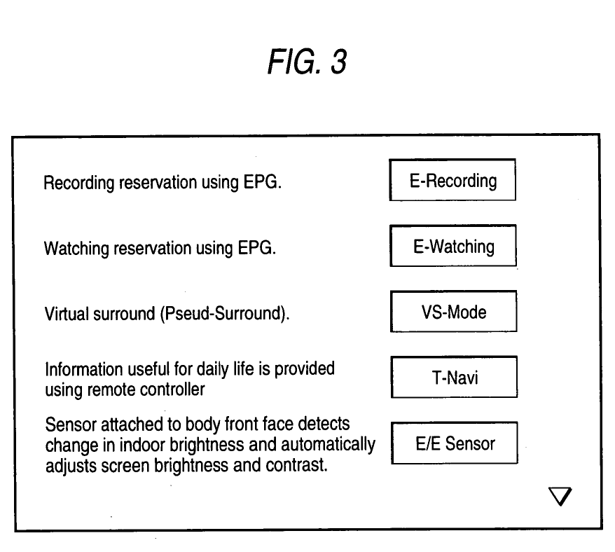

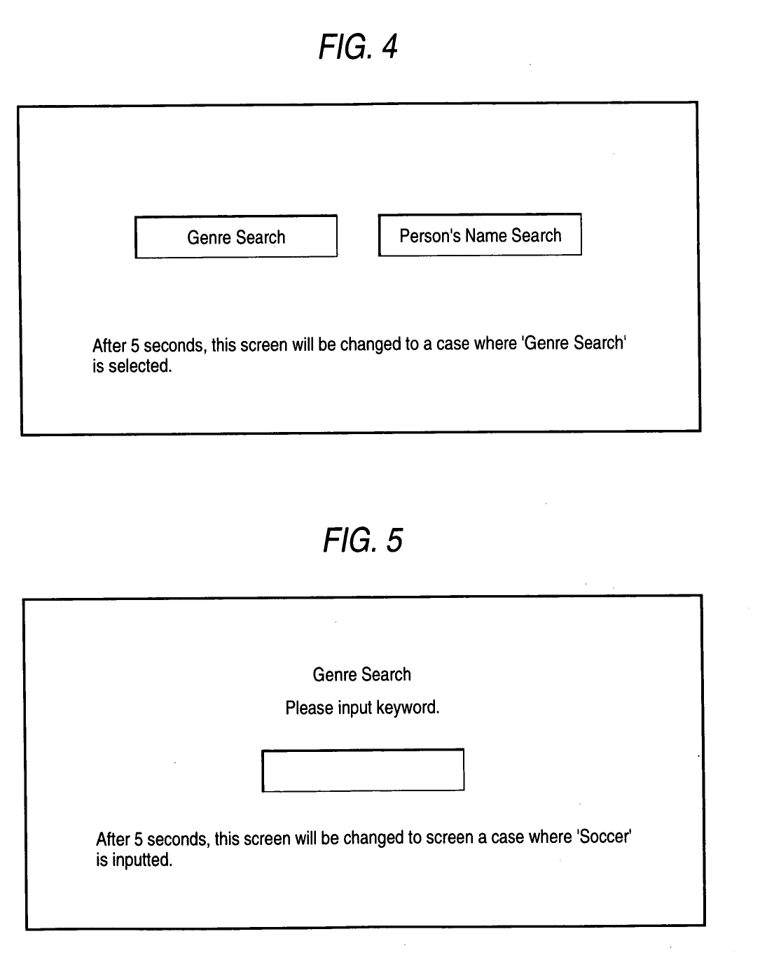

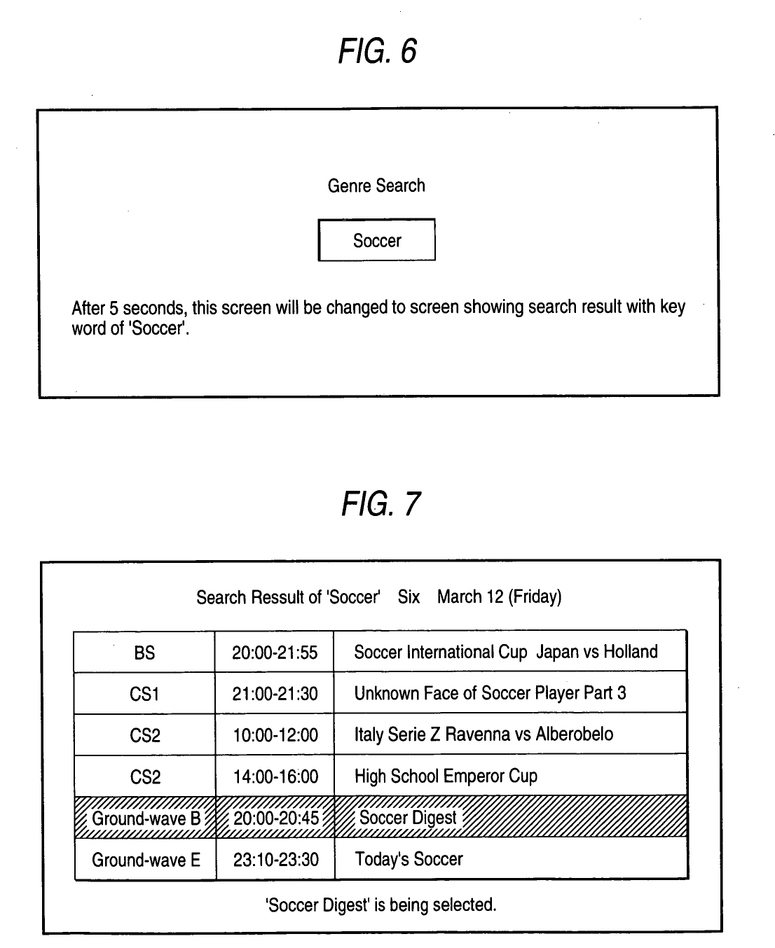

The user employs this demonstration mode when he cannot understand the contents of a key(s) from the name appended to the key attached to the remote controller 20. The user operates a demonstration key attached to e.g. the remote controller 20. Thus, a control signal designating the change into the demonstration mode is transmitted. When the remote control receiving unit 12 receives this control signal, it notifies the control unit 2 that changing the mode has been designated. The control unit 2 changes the operation mode of the body of the TV-integral type DVD player 1 from the normal mode to the demonstration mode, and notifies the video output unit 6 and audio output unit 9 that the operation mode has been changed from the normal mode into the demonstration mode. In response to this notification, the video output unit 6 reads out the guidance screen from the storage unit 7 and supplies it to the image display unit 8 (S1). The video output unit 6 interrupts the processing for the video signals transmitted from the tuner 4 or DVD processing unit 5 and does not supply these video signals. The audio output unit 9 is subjected to muting. At this time, the guidance screen as shown in FIG. 3 is displayed on the image display unit 8.

This guidance screen represents the names of the keys of the remote controller 20 and the contents of the functions which can be used when depressing the keys in such a manner that they are correlated with each other. For this reason, the user can see the guidance screen to confirm the functions of the keys which cannot be understood from their names appended to the keys on the remote controller 20. In other words, when the user cannot know the usable functions on the basis of the names appended to the keys attached to the remote controller 20, he has only to operate the demonstration key to confirm the contents of the usable functions.

Now, an explanation will be given of the case where the user wants to know the operating procedure of EPG (Electronic Program Guide) recording and has operated an EPG key.

At this time, if the user depresses an end key without operating the function key (S3), this processing is ended so that operation mode is restored to the normal mode. When the function key is operated (S2), for example when the user operates the key of EPG recording, the TV-integral type DVD player 1 executes the demonstration which guides the operating procedure when using the function corresponding to the operated key (S4).

The EPG recording is a function of searching the program corresponding to a genre or a person's name inputted using the EPG and showing the searched program for the user, thereby receiving the program to be recording-reserved.

First, a screen on which two buttons of “genre search” and “person's name search” are exhibited is displayed. Now, the demonstration for guiding the operating procedure based on the genre search will be done. In the demonstration mode, a message is shown on the lower part of the screen. In order that the user can know by what procedure the pertinent screen will be shifted, for example, the message is shown that “after five seconds, this screen will be changed to the screen showing a case where the genre search is selected”. When changed to the screen of genre search, as shown in FIG. 5, the screen in which the key word for the genre search is to be written is shown. On the lower part, the message is shown that “after five seconds, this screen will be changed to the screen showing a case where ‘soccer’ is inputted”. Thus, the preceding screen is changed to the screen in which the key word of ‘soccer’ has been written.

On the lower part of this screen, the message is shown that “after five seconds, this screen will be changed to the screen showing the searching result with the keyword of ‘soccer’”. Thereafter, as shown in FIG. 7, the screen showing the searching result with the key word of ‘soccer’ is shown.

On the lower part of this screen, the message is shown that this screen is in a status where “soccer digest is being selected”.

After a predetermined time passes, the demonstration mode is ended so that the screen is returned to the guidance screen as shown in FIG. 3. As understood from the above description, when the guidance screen is being displayed, the operating procedure when using the function corresponding to the control signal transmitted from the remote controller is shown. For this reason, the user can easily confirm the operating procedure of the function he cannot understand. Thus, the function attached to the device body can be effectively employed by the user. It should be noted that this invention can be applied to not only the TV-integral type DVD player but also other electronic devices such as a television receiver, a DVD player, a TV-integral type VTR, an AV amplifier, and a car navigation system.

1. An electronic device operated by a remote controller having keys, the electronic device comprising:
a device body;
a remote control receiving unit for receiving a control signal designating an operation of the device body transmitted from the remote controller to control the operation of the device body based on the received control signal;
a mode changing means for selectively changing an operation mode of the device body between a normal mode and a demonstration mode that explains functions provided to the device body;
a guidance image outputting means for outputting, when the mode changing means changes the operation mode of the device body from the normal mode to the demonstration mode, a guidance screen on which contents of the functions of the device body and names of the keys attached to the remote controller and operated when the functions are used are correlated with each other;
a demonstration means for guiding, when the guidance image outputting means is outputting the guidance screen, an operating procedure when the function corresponding to the control signal transmitted from the remote controller is used, the demonstration means outputting an operation guiding screen for guiding the operating procedure;
a reproducing means for reading/reproducing video and audio data recorded on a DVD set in the device body; and
a display means for displaying the guidance screen outputted by the guidance image outputting means and the operation guiding screen outputted by the demonstration means.

2. An electronic device operated by a remote controller having keys, the electronic device comprising:
a device body;
a remote control receiving unit for receiving a control signal designating an operation of the device body transmitted from the remote controller to control the operation of the device body based on the received control signal;
a mode changing means for selectively changing an operation mode of the device body between a normal mode and a demonstration mode that explains functions provided to the device body;
a guidance image outputting means for outputting, when the mode changing means changes the operation mode of the device body from the normal mode to the demonstration mode, a guidance screen on which contents of functions of the device body and names of the keys attached to the remote controller and operated when the functions are used are correlated with each other; and
a demonstration means for guiding, when the guidance image outputting means is outputting the guidance screen, an operating procedure when the function corresponding to the control signal transmitted from the remote controller is used.

3. The electronic device according to claim 2, wherein the demonstration means outputs an operation guiding screen for guiding the operating procedure; and
the electronic device further comprises a display means for displaying the guidance screen outputted by the guidance image outputting means and the operation guiding screen outputted by the demonstration means.

4. The electronic device according to claim 2, further comprising a reproducing means for reading/reproducing video and audio data recorded on a DVD set in the device body.
